(19) United States
(12) Patent Application Publication
(10) Pub. No.: US 2016/0178067 A1
(43) Pub. Date: Jun. 23, 2016

(54) VALVE BODY AND SEAT WITH TONGUE AND GROOVE CONNECTION

(71) Applicant: Mueller International, LLC, Atlanta, GA (US)

(72) Inventor: Ashraf Abouelleil, Oswego, IL (US)

(21) Appl. No.: 14/573,287

(22) Filed: Dec. 17, 2014

(51) Int. Cl. F16K 1/22

(52) U.S. Cl. CPC F16K 1/22

(57) ABSTRACT

A valve assembly includes a valve body having a valve body having an inner surface defining a groove between a first end of the inner surface and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole; a seat having an outer surface defining a rib extending outward between a first end of the outer surface and a second end of the outer surface, the rib having a rib outer surface, the rib positioned in the groove and extending from the upper neck shaft hole to the lower neck shaft hole, the groove defining a gap between the groove bottom surface and the rib outer surface.

### TECHNICAL FIELD

This disclosure relates to valve assemblies. More specifically, this disclosure relates to valve bodies and seats of butterfly valve assemblies.

### BACKGROUND

Valves and valve assemblies may be used for controlling or regulating the flow of a fluid such as water through various types of passageways by opening, closing, or partially obstructing the various passageways. In various applications, valve seats may be used to provide a seating surface for a disc of the valve. Butterfly valves typically include a disc that interacts with a seat by turning the disc within a body of the butterfly valve to engage the seat and seal a fluid pathway defined through the body. In closed valve positions, the seat and disc may form a seal to stop the flow of fluid. However, in various applications, cycling of the valve may cause seat movement in a radial and axial direction. Additionally, in various applications, although a seal may be formed between the disc and the seat, leak lines may form between the seat and the valve body. In addition, the torque required to close or open a valve may be a consideration in the design and manufacture of a valve and lowering the required torque may be desirable in various situations.

### SUMMARY

Disclosed is a valve assembly including a valve body having an inner surface defining a groove between a first end of the inner surface and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole; a seat having an outer surface defining a rib extending outward between a first end of the outer surface and a second end of the outer surface, the rib having a rib outer surface, the rib positioned in the groove and extending from the upper neck shaft hole to the lower neck shaft hole, the groove defining a gap between the groove bottom surface and the rib outer surface.

Also disclosed is a method of manufacturing a valve assembly including forming a valve body having an inner surface defining a groove between a first end and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole; forming a seat with an outer surface defining a rib extending outward between a first end and a second end of the outer surface; and inserting the seat into the valve body by inserting the rib into the groove such that the rib extends from the upper neck shaft hole to the lower neck shaft hole and a gap is defined between a rib outer surface of the rib and the groove bottom surface of the groove.

Also disclosed is a method of operating a valve assembly, the method including rotating a disc of the valve assembly, the valve assembly further including: a valve body having an inner surface defining a groove between a first end of the inner surface and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole; a seat having an outer surface defining a rib between a first end of the outer surface and a second end of the outer surface, the rib having a rib outer surface, the rib positioned in the groove and extending from the upper neck shaft hole to the lower neck shaft hole, the groove defining a gap between the groove bottom surface and the rib outer surface; engaging the disc with the seat to close a central opening of the seat.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a valve assembly in accordance with one embodiment of the current disclosure with the valve in a closed position.

FIG. 2 is a perspective view of a valve assembly in accordance with another embodiment of the current disclosure with the valve in an open position.

FIG. 3 is an exploded perspective view of the valve assembly shown in FIG. 2.

FIG. 4 is a front view of a valve body of the valve assembly shown in FIG. 2.

FIG. 5 is a cross-sectional view of the valve body shown in FIG. 4 taken along line 5-5 in FIG. 4.

FIG. 6 is an enlarged cross-sectional view of a portion of the valve body shown in FIG. 5.

FIG. 7 is a perspective view of a seat of the valve assembly shown in FIG. 2.

FIG. 8 is a front view of the seat shown in FIG. 7.

FIG. 9 is a cross-sectional view of the seat shown in FIG. 7 taken along line 9-9 in FIG. 8.

FIG. 10 is an enlarged cross-sectional view of a portion of the seat shown in FIG. 9.

FIG. 11 is a front view of the seat shown in FIG. 7 inserted into the valve body shown in FIG. 4.

FIG. 12 is a cross-sectional view of the seat inserted into the valve body shown in FIG. 11 taken along line 11-11 in FIG. 11.

FIG. 13 is an enlarged cross-sectional view of a portion of the seat inserted into the valve body shown in FIG. 12.

FIG. 14 is a table showing the reduced operating torque of a butterfly valve assembly shown in FIG. 2.

### DETAILED DESCRIPTION

Disclosed is a valve assembly and associated methods, systems, devices, and various apparatus. The valve assembly includes a valve body and a seat. It would be understood by one of skill in the art that the disclosed valve body and seat are described in but a few exemplary embodiments among many. No particular terminology or description should be considered limiting on the disclosure or the scope of any claims issuing therefrom.

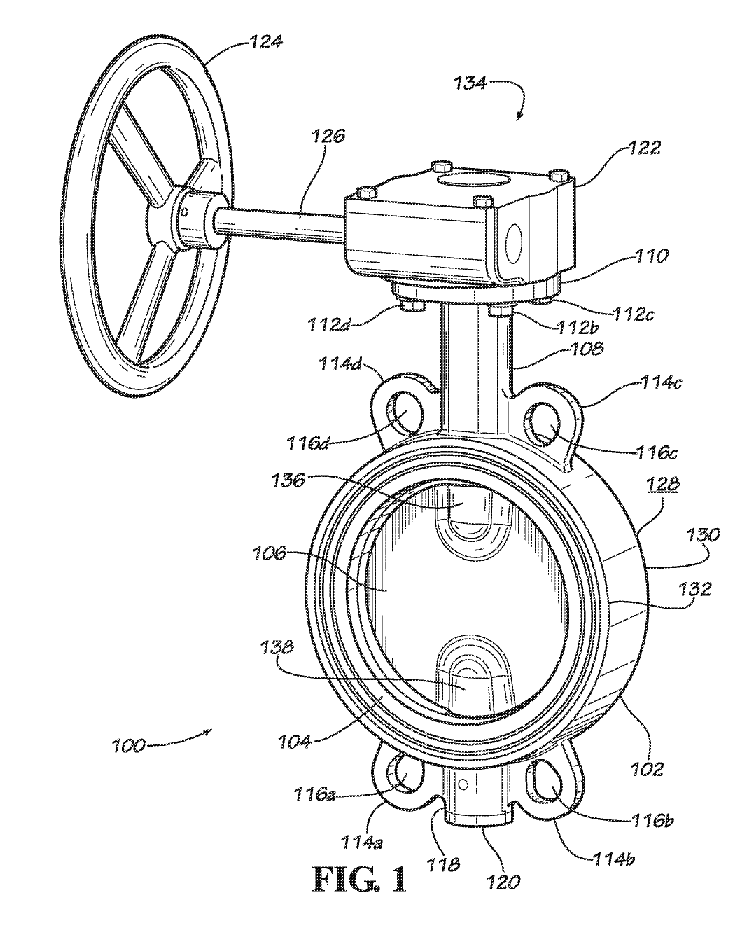

One embodiment of a valve assembly 100 is disclosed and described in FIG. 1. In various embodiments, the valve assembly 100 may be a butterfly valve assembly; however, in other embodiments, other suitable types of valve assemblies may be utilized. The valve assembly 100 includes a body 102, a seat 104, and a disc 106. In various embodiments, the body 102 may have a substantially annular or tubular shape and define a central axis; however, other shapes of the body 102 may be present in various other embodiments. The body 102 includes a first end 130 and a second end 132 distal from the first end 130. As shown in FIG. 1, the body 102 further includes an outer surface 128 extending from the first end 130 to the second end 132.

In various embodiments, the body 102 may include an upper neck 108 extending radially outwards from the outer surface 128. The body 102 may also include a lower neck 118 extending radially outward from the outer surface 128. In various embodiments, the lower neck 118 extends radially outward from the outer surface 128 at a location on the outer surface 128 opposite from the location of the upper neck 108 on the outer surface 128. The upper neck 108 and lower neck 118 may have a substantially annular or tubular shape with a central axis perpendicular to the central axis of the body 102; however, the upper neck 108 and lower neck 118 may have other shapes in various other embodiments.

In various embodiments, a bottom cap 120 may be attached to the lower neck 118 and may seal off one end of the lower neck from the outside environment. Additionally, in various embodiments, the upper neck 108 may also include a top flange 110. In these embodiments, the top flange 110 may be at an end of the upper neck 108 distal from the outer surface 128. The top flange 110 may provide a location at which an actuator system 134 may attach to the valve assembly 100. In various valve applications, the actuator system 134 enables the disc 106 of the valve assembly 100 to rotate between an open position and a closed position. The open position may be defined as the position where the plane of the disc 106 is parallel to the central axis of the body 102. In the open position, material may flow through the valve assembly. The closed position may be defined as the position where the plane of the disc 106 is perpendicular to the central axis of the body 102. In the closed position, the disc 106 and seat 104 may form a seal preventing the flow of material through the valve assembly 100.

As shown in FIG. 1, in various embodiments, the actuator system 134 may be a gear actuator system that includes a wheel 124, an actuator housing 122 for the gear, and a rod 126 connecting the wheel 124 to the gear in the actuator housing 122. As shown in FIG. 1, in the present embodiment, the actuator housing 122 of the actuator system 134 may be secured to the top flange 110 of the valve assembly 100 with fasteners 112. In the present embodiment, the fasteners 112 are screws; however in various other embodiments, other suitable attachment mechanisms may be used. Although a gear actuator system is shown in FIG. 1, in various other embodiments, the actuator system may be a lever actuator system, pneumatic actuator system, electric actuator system, or any other desired actuator system.

In various embodiments, the body 102 may also include alignment flanges 114 extending radially from the outer surface 128 and alignment holes 116 defined in the alignment flanges 114. In various embodiments, the body 102 may include any number of alignment flanges 114 and any number alignment holes 116. The alignment flanges 114 and alignment holes 116 may allow the valve assembly 100 to be positioned and secured between two pipe sections (not shown). In various embodiments, bolts (not shown) may pass through the alignment holes 116 and allow the valve assembly 100 to be positioned and secured between the pipe sections. In the present embodiment, the body 102 includes four alignment flanges 114a,b,c,d and four alignment holes 116a,b,c,d; however, in various other embodiments, any desired number of alignment flanges 114 and alignment holes 116 may be present. As shown in FIG. 1, in various embodiments, in addition to being connected to the outer surface 128, the alignment flanges 114 may be connected to the upper neck 108, lower neck 118, or both necks 108,118. In the present embodiment, the alignment flanges 114 have a rounded shape and the alignment holes 116 have an oval shape; however, in various other embodiments, the alignment flanges 114 and alignment holes 116 may have a circular, elliptical, square, rectangular, or any other desired shape.

The valve assembly 100 also includes the disc 106 and seat 104 positioned between the disc 106 and the body 102. As shown in FIG. 1, the disc 106 may have a substantially circular shape. In various embodiments, the disc 106 may define an upper shaft receiving portion 136 and a lower shaft receiving portion 138. In these embodiments, the valve assembly 100 includes an upper shaft inserted through the upper neck 108 and seat 104 and into the upper shaft receiving portion 136. The valve assembly 100 also includes a lower shaft inserted through the lower shaft receiving portion 138 and seat 104 and into the lower shaft receiving portion 138. In these embodiments, the upper shaft and lower shaft may rotably secure the disc 106 within the body 102. Although two stems and two shaft receiving portions are described with the current embodiment, in various other embodiments, a single shaft may be used and the disc 106 may define a single shaft receiving portion extending through the disc 106 across the diameter of the disc 106.

As previously described, in various embodiments, the disc 106 may also be positioned within a seat 104. In these embodiments, the seat 104 forms a seating surface for the disc 106. In various embodiments, the seat 104 may be constructed from a single or continuous piece of material. In various embodiments, the seat 104 may be constructed from a deformable material. In various embodiments, when the disc 106 is positioned on the seating surface of the seat 104 and both are placed in the body 102, the seat 104 may separate the disc 106 from the body 102. In these embodiments, when the seat 104 is inserted into the body 102, an outer surface of the seat 104 may mate with an inner surface of the body 102 and lock the seat 104 in place. In these various embodiments, when the valve assembly 100 is cycled, the locking of the seat 104 may prevent radial and axial movement of the seat 104.

Additionally, in various embodiments, when the outer surface of the seat 104 mates with the inner surface of the body 102, a seal may be formed between the seat 104 and body 102. This seal may be formed around the entire inner surface of the body 102. In various embodiments, when the valve assembly 100 is in a closed position, the seal between the seat 104 and the body 102 and the seal formed at the seating surface between the seat 104 and the disc 106 may prevent the flow of material through the valve assembly 100.

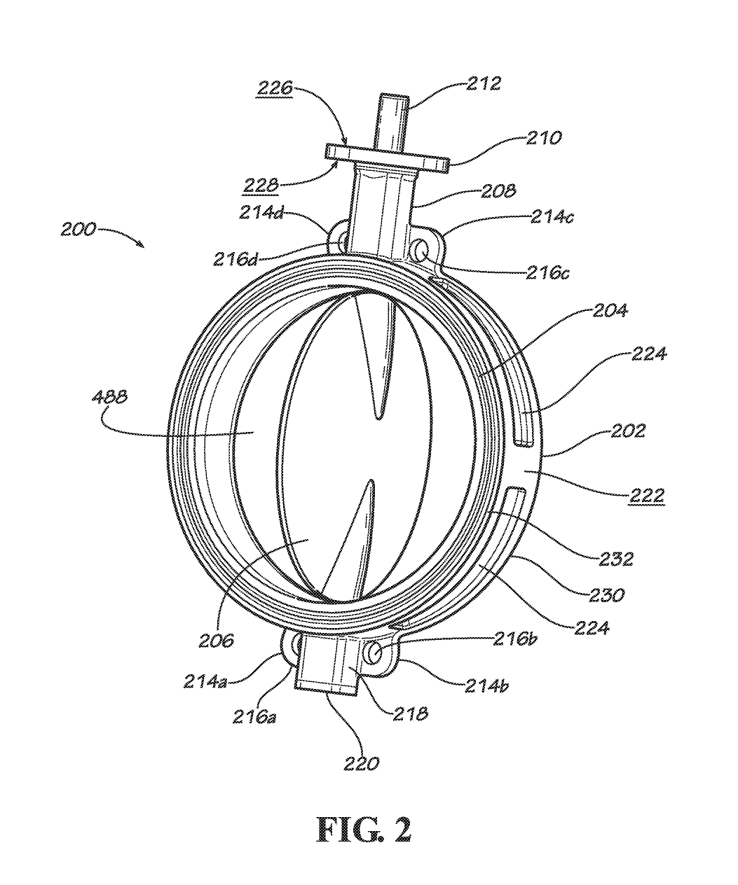

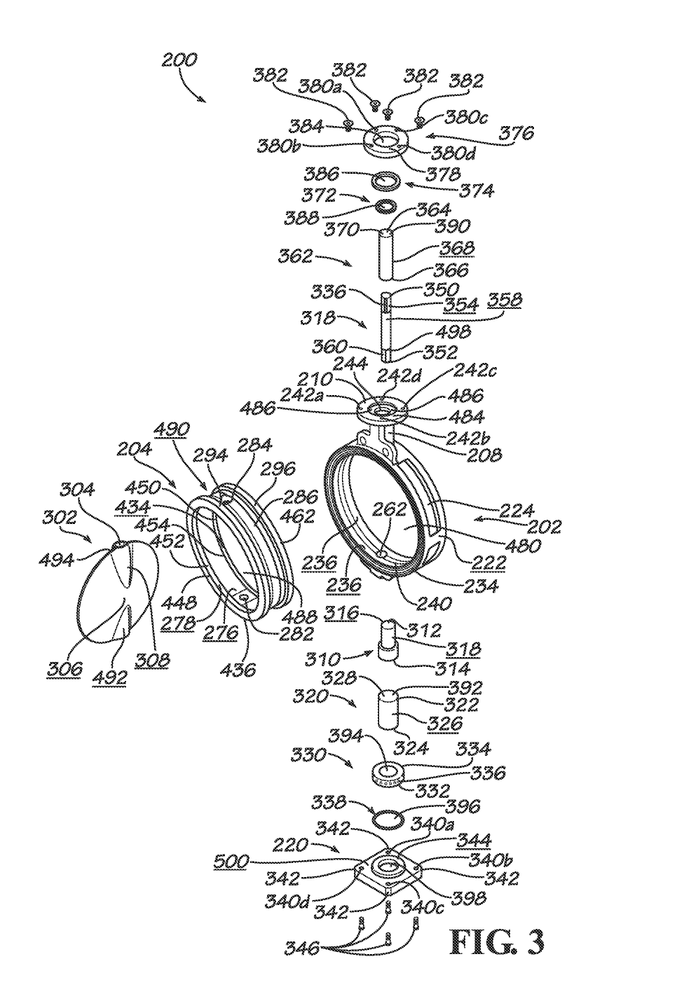

Another embodiment of a valve assembly 200 is disclosed and described in FIGS. 2 and 3. In particular, FIG. 2 shows a valve assembly 200 without an actuator system attached to the valve assembly 200. FIG. 3 shows an exploded view of the valve assembly 200. In various embodiments, aspects of valve assembly 200 may be similar to aspects of valve assembly 100, including the engagement of the seat 104 with the disc 106 and the body 102.

In various embodiments, the valve assembly 200 may be a butterfly valve assembly. The valve assembly 200 includes a body 202, a seat 204, and a disc 206. The body 202 is similar to body 102 with elements of the body 102 sized differently than the body 202. In these embodiments, the body 202 has a substantially annular or tubular shape with a central axis and may define a central opening 480; however, other shapes of the body 202 may be present in various other embodiments. The body 202 includes a first outer end 230 and a second outer end 232 distal from the first outer end 230. In various embodiments, the body 202 may have a one-piece construction made from ductile iron; however, in various other embodiments, the body may be made from cast iron, cast bronze, stainless steel, carbon steel, aluminum, plastic, or any other suitable material. Additionally, in various other embodiments, the body 202 may have a multiple-piece construction with various components attached together to create the body 202.

The body 202 further includes an outer surface 222 extending between the first outer end 230 and the second outer end 232. In various embodiments, the outer surface 222 may include one or more grooves 224 defined in the outer surface 222 between the first outer end 230 and the second outer end 232. As shown in FIG. 2, in various embodiments, the grooves 224 may have a generally rectangular shape; however, in various other embodiments, the grooves may have a square, elliptical, or any other desired shape.

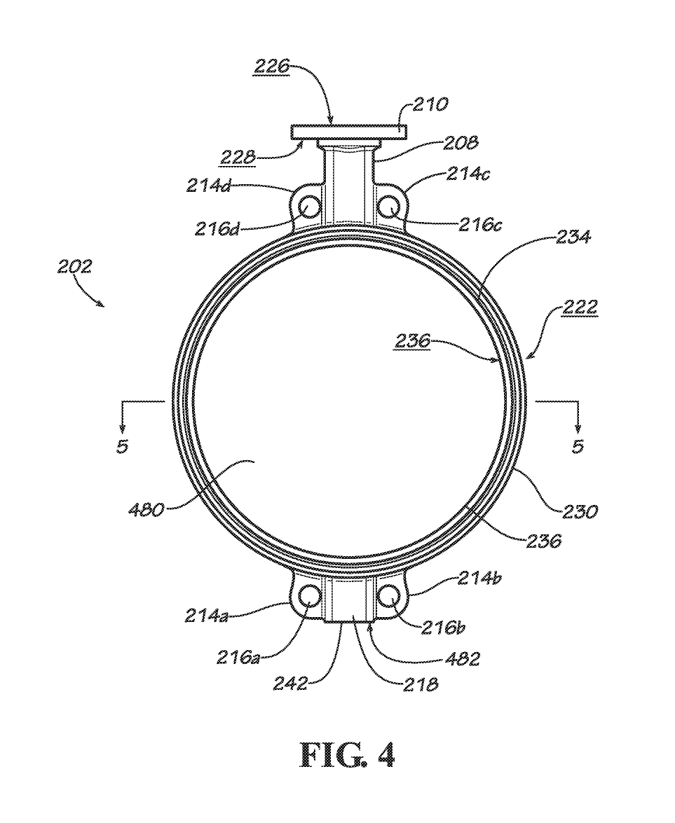

In various embodiments, the body 202 may include an upper neck 208 extending radially outwards from the outer surface 222. The body 202 may also include a lower neck 218 extending radially outwards from the outer surface 222. In preferred embodiments, the lower neck 218 extends radially from the outer surface 222 at a location on the outer surface 222 opposite from the location of the upper neck 208 on the outer surface. The upper neck 208 and lower neck 218 may have a substantially annular or tubular shape with a central axis perpendicular to the central axis of the body 202; however, the upper neck 208 and lower neck 218 may have other shapes in various other embodiments. In various embodiments, the upper neck 208 may define an upper neck shaft hole 244 and the lower neck 218 may define a lower neck shaft hole 262. The upper neck shaft hole 244 may extend through the body 202 from an top surface 226 of a top flange 210 to the inside of the body 202 defined by a center groove 240 and an inner surface 236. The lower neck shaft hole 262 may extend through the body 202 from a lower end 482 (shown in FIG. 4) of the lower neck 218 to the inside of the body 202.

In various embodiments, the valve assembly 200 may include an end cap 220 attached to the lower end 482 (shown in FIG. 4) of the lower neck 218. This end cap 220 may seal off one end of the lower neck 218 from the outside environment.

As shown in FIGS. 2 and 3, in various embodiments, the upper neck 208 may include a top flange 210. In these embodiments, the top flange 210 may be defined at the end of the upper neck 208 distal from the outer surface 222. The top flange 210 includes a top surface 226 and a lower surface 228. The top surface 226 may provide a location at which an actuator system may attach to the valve assembly 200. In these embodiments, the top flange 210 may include fastener holes 242 through which fasteners secure an actuator system to the valve assembly 200. In the present embodiment, the top flange 210 includes four fastener holes 242a,b,c,d; however, in various other embodiments, the top flange may include zero, one, two, three, or any desired number of fastener holes 242. As shown in FIG. 3, in various embodiments, the top flange 210 may also define a first recessed seat 484 and a second recessed seat 502. In these embodiments, the second recessed seat 502 may be configured to accept a sealing mechanism such as a V-type packing ring 372. The first recessed seat 484 may include fastener holes 486 through which fasteners 382 may secure a top cap 376 to the body 202. In these embodiments, the recessed seat 484 is dimensioned such that the top cap 376 may be inserted into the recessed seat 484 and an upper surface 378 of the top cap 376 is flush with the top surface 226 of the top flange 210.

As shown in FIG. 2, the body 202 may also include alignment flanges 214, which may be similar to alignment flanges 114, extending radially outwards from the outer surface 222. In various embodiments, the body 202 may also include alignment holes 216 defined in the alignment flanges 214. In various embodiments, the body 202 may include any number of alignment flanges 214 and any number of alignment holes 216. In the present embodiment, the body 202 includes four alignment flanges 214a,b,c,d and four alignment holes 216a,b,c,d; however, in various other embodiments, any desired number of alignment flanges 214 and alignment holes 216 may be present. As shown in FIG. 2, in various embodiments, in addition to being connected to the outer surface 222, the alignment flanges 214 may be connected to the upper neck 208, lower neck 218, or both necks 208,218. In the present embodiment, the alignment flanges 214 have a rounded shape and the alignment holes 216 have a circular shape; however, in various other embodiments, the alignment flanges 214 and alignment holes 216 may have an elliptical, square, rectangular, or any other desired shape.

In addition to the outer surface 222, the body 202 also includes the inner surface 236 and the center groove 240 defined by the inner surface 236. Additionally, between the outer surface 222 and the inner surface 236, the body 202 may define a first side groove 234. A more detailed description of the body 202 will be discussed below with reference to FIGS. 4-6.

As described above, the valve assembly 200 includes the seat 204. In various embodiments, the seat 204 may be similar to seat 104. In particular, in various embodiments, the seat 204 and elements of the seat 204 discussed below may be a single or continuous piece of material. More specifically, as described below, in various embodiments, the seat 204 may include elements such as various grooves, flanges, ribs, and surfaces. In various embodiments, these various elements such as grooves, flanges, ribs, and surfaces may be integrally formed with the seat 204. In various embodiments, integrally forming the various elements of the seat 202 eliminates potential leak lines and enables the valve assembly 200 to form a fluid tight seal. In various embodiments, the material may be a deformable but resilient material. In various embodiments, the seat 204 may be constructed from a material such as ethylene propylene diene monomer (EPDM) rubber, nitrile rubber (Buna-N), fluoroelastomers such as the material sold by E.I. du Pont de Nemours and Company (DuPont), Wilmington, Del. under the trade name VITON®, or any other suitable material.

As shown in FIG. 3, in various embodiments, the seat 204 may have a substantially annular or tubular shape with a central axis and defining a central opening 488; however, other shapes of the seat 204 may be present in various other embodiments. The seat 204 includes a first outer end 436, a second outer end 462 distal from the first outer end 436, and a center channel 490 defined between the first outer end 436 and second outer end 462. The seat 204 may also include a first inner end 448 and a second inner end 450 distal from the first inner end 448. In various embodiments, the seat 204 may define a first flange 294 at the first outer end 436, a second flange 296 at the second outer end 463, and a center rib 286 in the center channel 490.

In various embodiments, the seat 204 may include an inner surface 276. In various embodiments, the inner surface 276 is the seating surface for the disc 206. The seat 204 may also include a surface 278 between the first inner end 448 and a first end 452 of the inner surface 276. In various embodiments, the seat 204 may also include a surface 434 between the second inner edge 450 and a second end 454 of the inner surface 276.

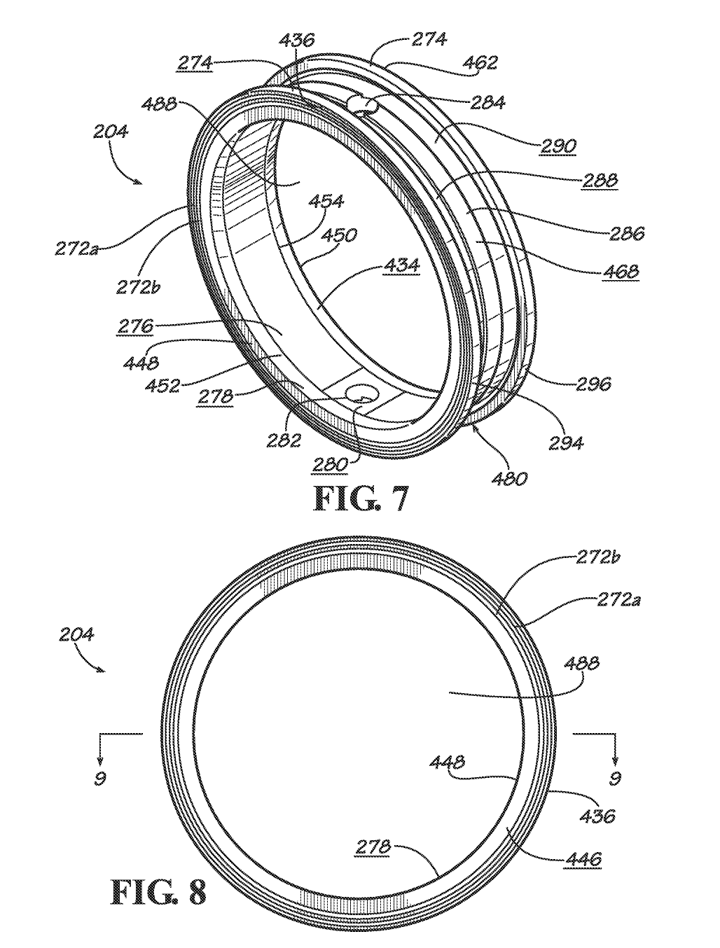

In various embodiments, the seat 204 may also include an upper shaft opening 284 at a first location on the seat 204 and a lower shaft opening 282 at a second location on the seat 204. In preferred embodiments, the lower shaft opening 282 may be at a position opposite from the position of the upper shaft opening 284. Both the upper shaft opening 284 may extend through the seat 204 from the inner surface 276 to the center channel 490. A more detailed description of the seat 204 will be discussed below with reference to FIGS. 7-10.

In addition to a body 202 and seat 204, the valve assembly 200 further includes the disc 206. In various embodiments, the disc 206 may be constructed from ductile iron; however, in various other embodiments, the disc 206 may be made from stainless steel, aluminum bronze, plastic, or any other similar material. Additionally, in various embodiments, the disc 206 may include any desirable coating applied through any desired method. In various embodiments, the disc 206 may include a coating such as Nylon 11, nickel-phosphorus or nickel-boron alloy applied through electroless nickel plating (ENP plating), or any other suitable coating.

As shown in FIG. 3, the disc 206 may define a side surface 306. In various embodiments, the side surface 306 may include a first raised surface 308 to accommodate an upper shaft receiving opening 304 and a second raised surface 492 to accommodate a lower shaft receiving opening. In these embodiments, the first raised surface 308 may extend radially inward from an outer edge 494 of the disc at a first location and the second raised surface 492 may extend radially inward from the outer edge 494 of the disc 206 at a second location. In various embodiments, the first raised surface 308 extends radially inward from the outer edge 494 at a position opposite from the position of the second raised surface 492. Although two stems and two shaft receiving portions are described with the current embodiment, in various other embodiments, a single shaft may be used and the disc 206 may define a single shaft receiving opening extending through the disc 206 across the diameter of the disc 206.

As shown in FIG. 3, in various embodiments, the valve assembly 200 may include components in addition to the body 202, seat 204, and disc 206. As shown in FIG. 3, in various embodiments, the valve assembly 200 may further include an upper shaft 212. In various embodiments, the upper shaft 212 may be constructed from stainless steel. In the present embodiment, the upper shaft 212 is constructed from Heat Treated 416 Stainless Steel; however, in various other embodiments, other materials may be used to construct the upper shaft 212. The upper shaft includes a first end 350, a second end 352 distal from the first end 350, a first intermediary position 496 between the first end 350 and the second end 352, and a second intermediary position 498 between the first intermediary position 496 and the second end 352. In various embodiments, the portion of the upper shaft 212 between the first intermediary position 496 and the second intermediary position 498 may have a substantially cylindrical shape and an outer surface 358; however, in various other embodiments, other shapes may be used. In various embodiments, the portion of the upper shaft 212 between the first intermediary position 496 and first end 350 may have a substantially cylindrical shape with an outer surface 354; however, in various other embodiments, other shapes may be used. In various embodiments as shown in FIG. 3, the outer surface 354 may also include a key 356 defined in the outer surface 354 for interaction with an actuator system. In various embodiments, the portion of the upper shaft 212 between the second end 352 and second intermediary position 498 may define a drive 360 for positively engaging the disc 206 at the upper shaft receiving opening 304. As shown in FIG. 3, in various embodiments, the drive 360 may be a square drive to create an internal square drive; however, in various other embodiments, other mechanisms for positively engaging the disc 206 may be used.

In various embodiments, the valve assembly 200 may further include a lower shaft 310. In various embodiments, the lower shaft 310 may be constructed from the same material as the upper shaft 212. Additionally, the lower shaft 310 may have a substantially cylindrical shape and include a first end 312 and a second end 314 distal from the first end 312; however, in various other embodiments, other shapes may be used. The lower shaft 310 defines an outer surface 318 extending from the first end 312 to the second end 314. Additionally, the lower shaft 310 defines an upper surface 316 at the first end 312 and a lower surface (not shown) at the second end 314. In the present embodiment, the first end 312 and upper surface 316 may be inserted into the lower shaft receiving opening of the disc 206 to rotably support the disc 206. Although two shafts are described in the present embodiment, as previously described, in various other embodiments, the valve assembly 200 may utilize a single shaft. In these alternative embodiments, the single shaft may include a drive portion for positively engaging the disc 206 and an engagement portion for engaging an actuator system. In various other embodiments, other shaft designs may be utilized.

The valve assembly 200 may also include an upper bushing 362 and a lower bushing 320. In these embodiments, the upper bushing 362 and the lower bushing 320 may be utilized to protect against friction, corrosion, and impacts. In various embodiments, the upper bushing 362 and lower bushing 320 may be constructed from a nylon plastic or other suitable material providing protection against friction, corrosion, and impacts. In particular, in various embodiments, the upper bushing 362 and lower bushing 320 may be constructed from the material sold by Quadrant EPP USA, Inc. (Quadrant), Reading, N.J. under the trade name NYLATRON®. In various other embodiments, other similar materials may be utilized.

As shown in FIG. 3, the upper bushing 362 may have a substantially annular or tubular shape with a central opening 390; however, other shapes may be present in various other embodiments. The upper bushing 362 includes a first end 364 and a second end 366 distal from the first end 364. In addition, the upper bushing 362 includes an outer surface extending between the first end 364 and the second end 366 and an inner surface 370 extending between the first end 364 and the second end 366. The lower bushing 320 may have a substantially annular or tubular shape with a central opening 392; however, other shapes may be present in various other embodiments. The lower bushing 320 includes a first end 322 and a second end 324 distal from the first end 322. Additionally, the lower bushing 320 includes an inner surface 328 extending between the first end 322 and the second end 324 and an outer surface 326 extending between the first end 322 and the second end 324.

In various embodiments, the valve assembly 200 may further include rotating mechanisms for permitting rotation of the lower shaft 310 relative to the end cap 220. As shown in FIG. 3, in various embodiments, the valve assembly 200 may include thrust ball bearings 330 as rotating mechanisms; however, in various other embodiments, other rotary ball bearings or other rotating mechanisms may be utilized to permit rotation between the lower shaft 310 and the end cap 220. As shown in FIG. 3, the thrust ball bearings 330 include ball bearings supported in a ring 336, a first washer 332, and a second washer 334. Additionally, in various embodiments, a central opening 394 is defined by the rotating mechanism.

In various embodiments, the valve assembly 200 may include a top cap 376. As shown in FIG. 3, the top cap 376 may be dimensioned to be inserted into the recessed seat 484 of the top flange 210 of the body 202. The top cap 376 may be substantially annular and include an upper surface 378 and a lower surface; however, in various other embodiments, other shapes may be used that may be inserted into the recessed seat 484. In various embodiments, the top cap 376 defines attachment openings 380 extending through the top cap 376 from the upper surface 378 to the lower surface. In the present embodiment, the top cap 376 includes four attachment openings 380a,b,c,d; however, in various other embodiments, any desirable number of attachment openings may be utilized. In various embodiments, the attachment openings 380 may be aligned with fastener holes 242 such that fasteners 382 may be inserted through openings 380 into fastener holes 242 and may secure the top cap 376 to the body 202. In the present embodiment, the fasteners 382 are screws; however, in various other embodiments, other fasteners may be utilized.

As shown in FIG. 3, in various embodiments, the valve assembly 200 may include the end cap 220. In various embodiments, the end cap 220 may have a generally rectangular shape with tapered edges 342; however, in various other embodiments, the end cap 220 may have any desired shape. The end cap 220 includes a top surface 500 and a bottom surface. In various embodiments, the bottom end cap also may include a raised surface 344 extending from the top surface 500 and defining a central bore 398. In various embodiments, the raised surface 344 may have an annular shape and be dimensioned to be inserted into the lower neck shaft hole 262; however, in various other embodiments, the raised surface 344 may have any desired shape. In addition, in various embodiments, the end cap 220 may define attachment openings 340 extending through the end cap 220 from the top surface 500 to the bottom surface. In the present embodiment, the end cap 220 includes four attachment openings 340a,b,c,d; however, in various other embodiments, any desirable number of attachment openings 340 may be utilized. The attachment openings 340 may be aligned with attachment openings on the lower surface of the body 102 at the lower end 482 (shown in FIG. 4) such that fasteners 346 may be inserted through openings 340 into attachment openings in the body 202 and may secure the end cap 220 to the body 202. In the present embodiment, the fasteners 346 are screws; however, in various other embodiments, other attachment mechanisms may be utilized.

As shown in FIG. 3, in various embodiments, the valve assembly 200 may include sealing mechanisms to seal the interface between a top cap 376 and the body 202 in the recessed seat 484. In various embodiments, the sealing mechanism may be dimensioned to be inserted into the second recessed seat 502. Additionally, in various embodiments, the sealing mechanism may be suitable for pressure or vacuum service and may create a positive seal against the top cap 376. In particular, in various embodiments, the sealing mechanism may be a V-type packing ring 372 that includes a central opening 388. However, in various other embodiments, other sealing mechanism may be utilized that create a seal against the top cap 376. The valve assembly 200 may also define movement mechanisms for permitting rotation between the sealing mechanism and the top cap 376. In various embodiments, the valve assembly 200 may include a bearing 374 which may have an annular shape and define a central opening 386; however, in various other embodiments, other shapes may be used.

In various other embodiments, the valve assembly 200 may include sealing mechanisms to seal the lower end 482 of the body 202 with the top surface 500 of the end cap 220. In various embodiments, the sealing mechanism may include an O-ring 338. In various embodiments, the O-ring may be positioned around the raised surface 344 on the end cap 220 such that when the end cap 220 is attached to the body 202, a positive seal is created against external leakage. In various other embodiments, other sealing mechanism may be utilized to create a positive seal between the body 202 and the end cap 220.

FIG. 4 shows a front view of one embodiment of the body 202 of the valve assembly 200 taken in isolation. As previously described, the body 202 may have a substantially annular shape that defines the central opening 480. Additionally, the body 202 may include the upper neck 208 and the lower neck 218. The upper neck 208 may include the top flange 210 that includes the top surface 226 and the lower surface 228. The lower neck 218 may include the lower end 482 distal from the outer surface 222 of the body 202.

As shown in FIG. 4, in various embodiments, the body 202 may define the first side groove 234 at the first outer end 230 of the body 202 by and between the outer surface 222 and the inner surface 236. In these embodiments, the first side groove 234 may extend continuously in a complete circle around the body 202 between the outer surface 222 and the inner surface 236.

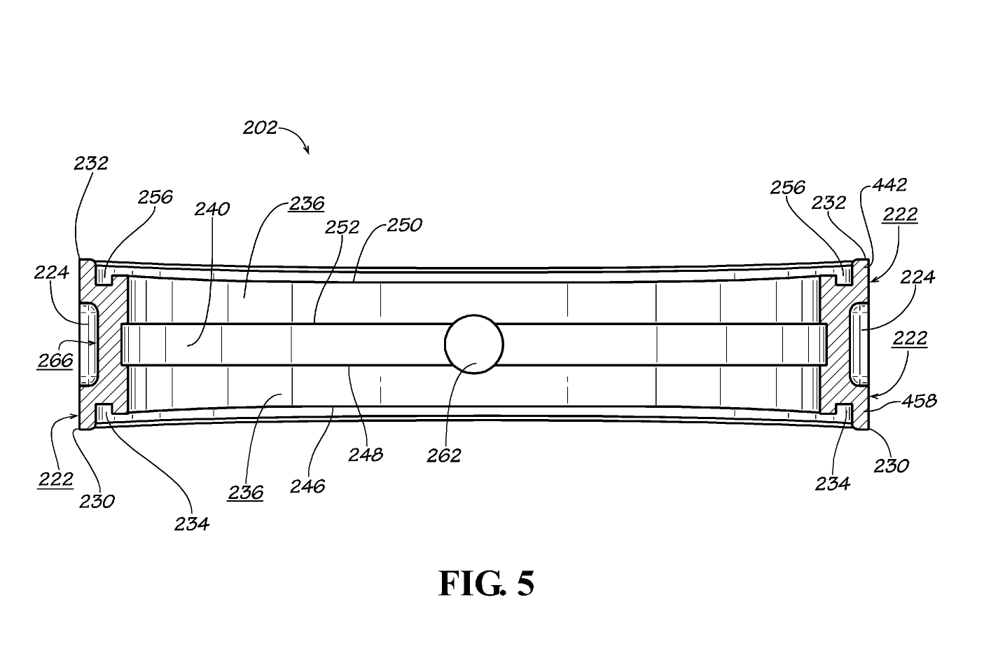

FIG. 5 is a cross-sectional view of one embodiment of the body 202 taken along line 3-3 in FIG. 4. As previously described, the body 202 includes the first outer end 230 and the second outer end 232 distal from the first outer end 230. The outer surface 222 extends between the first outer end 230 and the second outer end 232. As previously described, in various embodiments, the body 202 may define grooves 224 defined in the outer surface 222 between the first outer end 230 and the second outer end 232. In these embodiments, the grooves 224 may define a groove inner surface 266 below the outer surface 222 of the body 202. Although in the present embodiment the grooves 224 have a rectangular shape, in various other embodiments the grooves 224 may have any desired shape. In various embodiments, the grooves 224 may only extend partially around the outer surface 222; however, in various other embodiments, a continuous groove 224 may be defined around the outer surface 222. In various other embodiments, the grooves 224 may have any desired shape or configuration.

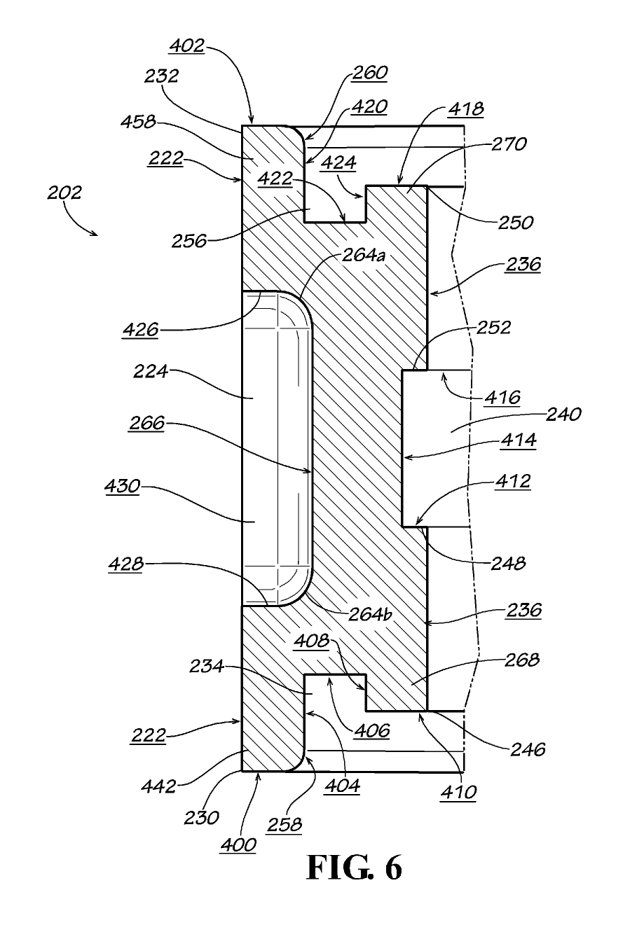

Additionally, in various embodiments, the body 202 may also include the inner surface 236. As shown in FIG. 5, the inner surface 236 defines a first outer end 246 and a second outer end 250. In various embodiments, the inner surface 236 defines a center groove 240 between the first outer end 246 and the second outer end 250. In these embodiments, the center groove 240 may include a first groove end 248 and a second groove end 252. In addition to the center groove 240, in various embodiments, the body 202 may also define the first side groove 234 and the second side groove 256. As shown in FIG. 5, in various embodiments, the first side groove 234 may be defined in the body 202 between the first outer end 246 of the inner surface 236 and the first outer end 230. The second side groove 256 may be defined in the body 202 between the second outer end 250 of the inner surface 236 and the second outer end 232. The surfaces and grooves of the body 202 will be described below in more detail with reference to FIG. 6.

In addition, as shown in FIG. 5, the lower neck shaft hole 262 extends through the inner surface 236 and the center groove 240. Although not shown, like the lower neck shaft hole 262, the upper neck shaft hole 244 also extends through the inner surface 236 and the center groove 240.

FIG. 6 is an enlarged view of one of the cross-sections of one embodiment of the body 202 shown in FIG. 5. In various embodiments, the body 202 includes the first outer end 230 and the second outer end 232. In addition, in various embodiments, the body 202 may include the first outer end 246 and the second outer end 250 of the inner surface 236. In various embodiments, the distance from the first outer end 246 to the second outer end 250 of the inner surface 240 is less than the distance from the first outer end 230 to the second outer end 232 of the outer surface 222.

As previously described, the outer surface 222 includes and extends between the first outer end 230 to the second outer end 232. Additionally, in various embodiments, the outer surface 222 may define grooves 224 in the body 202. As shown in FIG. 6, the grooves 224 may have a groove inner surface 266 below the outer surface 222 of the body 202. In various embodiments, the grooves 224 also have a first side surface 426, a second side surface 428, and an end side surface 430; however, in various other embodiments where the grooves 224 are not rectangular in shape, the grooves 224 may include fewer or additional surfaces. Additionally, as shown in FIG. 6, in various embodiments, the grooves 224 may define a rounded edge 264 between the side surfaces and the groove inner surface 266. For example, as shown in FIG. 6, the grooves 224 may define rounded edge 264a between the first side surface 426 and the groove inner surface 266 and rounded edge 264b between the second side surface 428 and the groove inner surface 266. Although two rounded edges 264 are shown in the present embodiment, the groove 224 may define any desired number of rounded edges 264 such as zero rounded edges 264 or a plurality of rounded edges 264.

A first side of the body 202 may defined as the portion of the body 202 between the first outer end 230 of the outer surface and the first outer end 246 of the inner surface 236. In various embodiments, the first side includes a first outer body flange 442 and a first inner body flange 268. The first outer body flange 442 includes a side surface 400 and a lower surface 404. In various embodiments, the first outer body flange 442 may further include a tapered edge 258 between the side surface 400 and the lower surface 404; however, in various other embodiments, any desired edge shape may be included such as straight, rounded, beveled, or any other edge shape.

The first inner body flange 268 includes a side surface 410 and an upper surface 408. In various embodiments, the side surface 410 is recessed within the body 202 relative to the side surface 400. In these embodiments, side surface 400 is the outermost side surface at the first side of the body 202.

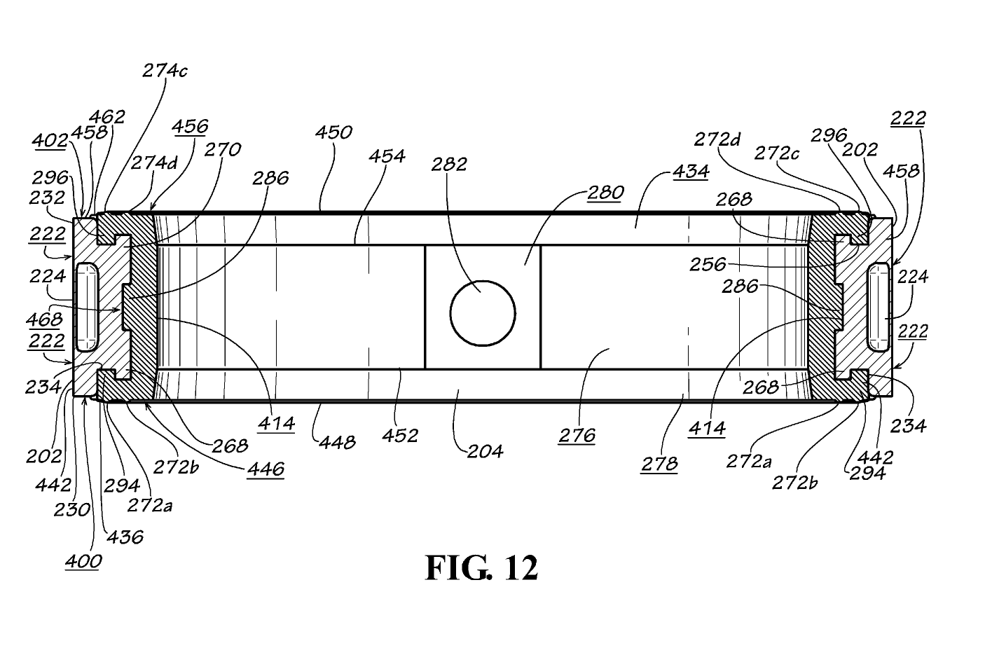

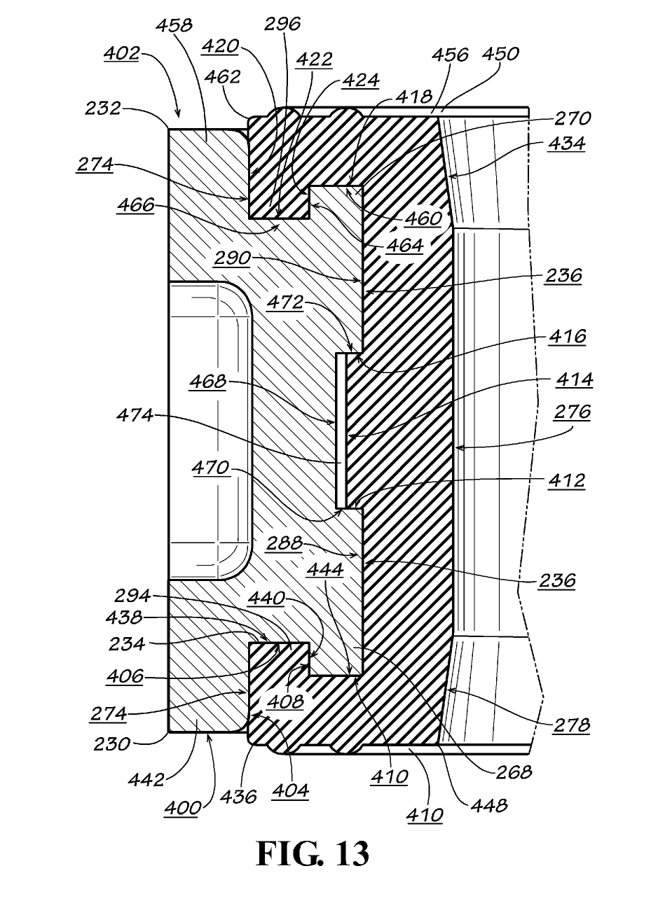

As previously discussed, in various embodiments, the body 202 defines the first side groove 234. As shown in FIG. 6, in various embodiments, the first side groove 234 may be defined between the lower surface 404 of the first outer body flange 442 and the upper surface 408 of the first inner body flange 268. In these embodiments, the first side groove 234 may extend continuously around the body 202 between the lower surface 404 and the upper surface 408. In various embodiments, in a cross-sectional view, the upper surface 408 may be parallel to the lower surface 404 of the first body outer extension 442 and the first side groove 234 may define a groove surface 406 extending between the upper surface 408 and the lower surface 404. In these embodiments, the surfaces 406,408,410 may define a square profile for the first side groove 234 when viewed in a cross-sectional view; however, in various other embodiments, the surfaces 406,408,410 may interact to define a non-square profile for the first side groove 234 when viewed in a cross-sectional view. For example, in various embodiments, the surfaces 406,408,410 may define a first side groove 234 with a rounded profile, angled profile, or any other desired profile shape. As will be discussed below with reference to FIGS. 12 and 13, the profile of the first side groove 234 defined by surfaces 406,408,410 should match the profile of a first flange 294 of the seat 204.

A lower side of the body 202 may be defined as the portion of the body 202 between the first outer end 246 and the second outer end 250. As previously described, in various embodiments, the body 202 may include the inner surface 236 and the center groove 240 defined by the inner surface 240.

As previously described, in various embodiments, the inner surface 236 of the body 202 may define the center groove 240 between the first outer end 246 and the second outer end 250. The center groove 240 may include the first groove end 248 and the second groove end 252. In these embodiments, the center groove 240 may extend continuously around the body 202 from the upper neck shaft hole 244 to the lower neck shaft hole 262 and between the first outer end 246 and the second outer end 250. In these embodiments, the groove 240 may further define a first side groove surface 412, a second side groove surface 416 distal from the first side groove surface 412, and a groove bottom surface 414. In various embodiments, the lower groove surface extends between the first groove end 248 and the second groove end 252. As shown in FIG. 6, in various embodiments, the groove bottom surface 414 may be recessed into the body 202 relative to the inner surface 236. In these embodiments, the center groove 240 may have a groove depth defined as the distance from the groove bottom surface 414 to the inner surface 236. In various embodiments, a groove width may be defined by the distance from the first groove end 248 to the second groove end 252. In various embodiments, the width of the groove 240 may be less than the width of the inner surface 236.

In various embodiments, the surfaces 414,416,418 may also define a groove profile when viewed in a cross-sectional view. As shown in FIG. 6, in various embodiments, the surfaces 414,416,418 may define a square profile for the groove 240; however, in various other embodiments, the surfaces 414,416,418 may interact to define a non-square profile for the groove 240. For example, in various embodiments, the surfaces 414,416,418 may define the groove 240 with a rounded profile, angled profile, or any other desired profile shape. As will be discussed below with reference to FIGS. 12 and 13, the profile of the groove 240 defined by surfaces 414,416,418 should match the profile of the center rib 286 of the seat 204 when viewed in a cross-sectional view.

A second side of the body 202 may defined as the portion of the body 202 between the second outer end 232 of the outer surface 222 and the second outer end 250 of the inner surface 236. In various embodiments, the second side includes a second outer body flange 458 and a second inner body flange 458. The second outer body flange 458 includes a side surface 402 and a lower surface 420. In various embodiments, the second outer body flange 458 may further include a tapered edge 260 between the side surface 402 and the lower surface 420; however, in various other embodiments, any desired edge shape may be included such as straight, rounded, beveled, or any other edge shape.

The second inner body flange 458 includes a side surface 418 and an upper surface 424. In various embodiments, the side surface 418 is recessed within the body 202 relative to the side surface 402. In these embodiments, side surface 402 is the outermost side surface at the second side of the body 202.

As previously discussed, in various embodiments, the body 202 defines the second side groove 256. As shown in FIG. 6, in various embodiments, the second side groove 256 may be defined between the lower surface 420 of the second outer body flange 458 and the upper surface 424 of the second inner body flange 458. In these embodiments, the second side groove 256 may extend continuously around the body 202 between the lower surface 420 and the upper surface 424. In various embodiments, when viewed in a cross-sectional view, the upper surface 424 may be parallel to the lower surface 420 of the second outer body flange 458 and the second side groove 256 may define a groove surface 422 extending between the outer surface 274 and the lower surface 422. In these embodiments, the surfaces 422,424,426 may define a square profile for the second side groove 256 when viewed in a cross-sectional view; however, in various other embodiments, the surfaces 422,424,426 may interact to define a non-square profile for the second side groove 256. For example, in various embodiments, the surfaces 422,424,426 may define the second side groove 256 with a rounded profile, angled profile, or any other desired profile shape. As will be discussed below with reference to FIGS. 12 and 13, the profile of the second side groove 256 defined by surfaces 422,424,426 should match the profile of the second flange 296 of the seat 204.

In these various embodiments, similar to the first side groove 234, the surfaces and grooves of the body 202 may extend continuously in a complete circle around the body 202. In particular, in various embodiments, the second side groove 256, the center groove 240 and the inner surface 236 may extend continuously around the body 202 at their respective locations on the body 202.

FIG. 7 shows a perspective view of one embodiment of the seat 204 of the valve assembly 200 taken in isolation. As previously described, in various embodiments, the seat 204 may have a substantially annular or tubular shape and define the central opening 488. The seat 204 includes an outer surface 274 defining and extending between the first outer end 436 and the second outer end 462. The outer surface 274 may also define the center channel 490 between the first outer end 436 and second outer end 462. The seat 204 also includes the first inner end 448 and the second inner end 450 distal from the first inner end 448.

In various embodiments, as previously discussed, the seat 204 may include the inner surface 276. As shown in FIG. 7, the inner surface 276 may include the first end 452 and a second end 454 distal from the first end 452. In these embodiments, the inner surface 276 may define a width equal to the distance from the first end 452 to the second end 454. In various embodiments, the seat 204 may define a rectangular planar surface 280 around the lower shaft opening 282. In these embodiments, surface 280 may be flattened to accommodate the portions of the disc 206 where the upper shaft 212 and lower shaft 310 connect with the disc 206.

In various embodiments, the first end 452 of the inner surface 276 may connect to the first inner end 448 through the surface 278. As shown in FIG. 7, in various embodiments, surface 278 may be a first tapered surface 278. In various embodiments, the first tapered surface 278 may facilitate guidance and insertion of the disc 302 into the central opening 488 of the seat. The first tapered surface 278 may also guide the disc 302 during operation such that the disc 302 contacts the inner surface 276 to form a fluid tight seal in a closed position. In various embodiments, the first tapered surface 278 may be tapered less than 45 degrees from the axial direction. In various embodiments, the first tapered surface 278 may be tapered less than 22.5 degrees from the axial direction. In various other embodiments, the surface 278 may not be tapered. Additionally, in various embodiments, the second end 454 of the inner surface 276 may connect to the second inner end 450 through the surface 434. As shown in FIG. 7, in various embodiments, surface 434 may be a second tapered surface 434 and provide benefits similar to those provided by tapered surface 278. Furthermore, the second tapered surface 434 may be tapered at angles similar to those of the first tapered surface 278; however, in various other embodiments, the surface 434 may not be tapered. Tapering the first tapered surface 278 and second tapered surface 434 at an angle less than 45 degrees or less than 22.5 degrees allows the disc 302 to rotate more easily into sealing contact with the seat 204 in various embodiments, with the first tapered surface 278 and second tapered surface 434 guiding the disc 302 into the closed position. However, angles greater than 45 degrees may be present in various embodiments and first tapered surface 278 or second tapered surface 434 may not be present at all in various other embodiments.

In various embodiments, the outer surface 274 of the seat 204 may define the first flange 294 at the first outer end 436. The outer surface 274 of the seat 204 may also define the second flange 296 at the second outer end 462. In various embodiments, the outer surface 274 of the seat 204 may further define the center channel 490 between the first outer end 436 and the second outer end 462. As shown in FIG. 7, the center channel 490 may define a first recessed surface 288, a second recessed surface 290, and a center rib 286 between the first recessed surface 288 and the second recessed surface 290. In various embodiments, the center rib 286 may define a center rib surface 468.

As previously described, in various embodiments, the seat 204 may include the upper shaft opening 284 at the first location on the seat 204 and the lower shaft opening 282 at the second location on the seat 204. As is partially shown in FIG. 7, in various embodiments, the upper shaft opening 284 may extend through the seat 204 from the inner surface 276 to the first recessed surface 288, the second recessed surface 290, and the center rib 286. In various embodiments, the seat 204 may include the lower shaft opening 282. As is partially shown in FIG. 7, in various embodiments, the lower shaft opening 282 may extend through the seat 204 from the inner surface 276 to the first recessed surface 288, the second recessed surface 290, and the center rib 286.

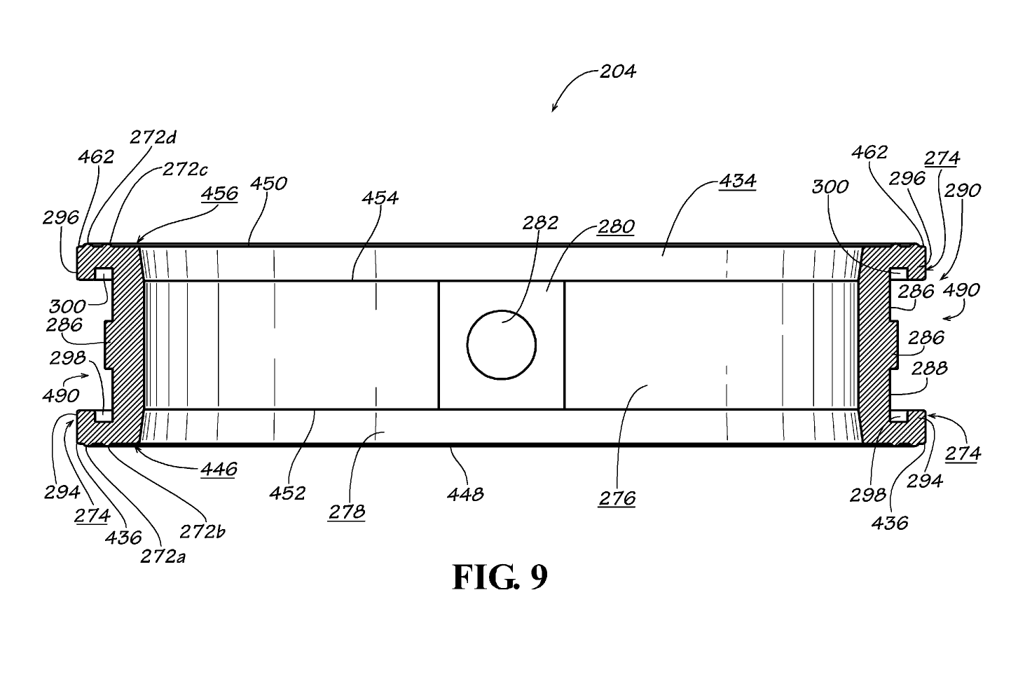

As shown in FIG. 7, in various embodiments, the seat 204 may also include side ribs 272. In the present embodiment, the seat includes four side ribs 272a,b,c,d (side ribs 272c,d are shown in FIG. 9). Although four side ribs 272 are shown in the present embodiment, any desired number of side ribs may be utilized in various other embodiments.

FIG. 8 shows a side view of one embodiment of the seat 204 taken in isolation. As shown in FIG. 8, the seat 204 may include the first side surface 446 extending between the first outer end 436 and the first inner end 448. In various embodiments, the side ribs 272a,b may be defined on the first side surface 446. In these embodiments, the side ribs 272a,b may extend continuously around the seat 204 at the side surface 446.

FIG. 9 shows a cross section of one embodiment of the seat 204 taken along line 9-9 in FIG. 8. As previously described, the seat 204 includes the first outer end 436 and the second outer end 462 distal from the first outer end 436. The seat 204 also may include the first inner end 448 and the second inner end 450 distal from the first inner end 448.

In various embodiments, the seat 204 defines the first side surface 446 extending between the first outer end 436 and the first inner end 448. As shown in FIG. 9, in various embodiments, the first side surface 446 may include side ribs 272. In the present embodiment, the first side surface 446 includes two side ribs 272a,b; however, in various other embodiments, any desired number of side ribs 272 may be utilized. In various embodiments, the seat 204 may also define a second side surface 456 extending between the second outer end 462 and the second inner end 456. As shown in FIG. 9, in various embodiments, the second side surface 456 may include side ribs 272. In the present embodiment, the second side surface 456 includes two side ribs 272c,d; however, in various other embodiments, any desired number of side ribs 272 may be utilized.

As previously described, in various embodiments, the outer surface 274 of the seat 204 may define the center channel 490 between the first outer end 436 and the second outer end 462. In various embodiments, the center channel 490 may be defined continuously around the seat 204 between the first outer end 436 and the second outer end 462. As shown in FIG. 9, in various embodiments, the center channel 490 includes the first recessed surface 288 and the second recessed surface 290. In various embodiments, the first recessed surface 288 and the second recessed surface 290 may be defined continuously around the seat 204 in the center channel 490. In various embodiments, the center channel 490 further includes the center rib 286 positioned between the first recessed surface 288 and the second recessed surface 290. In various embodiments, the center rib 286 may be defined continuously around the seat 204 in the center channel 490. In various embodiments, the center channel 290 including the center rib 286 may extend continuously around the body 202 from the upper shaft opening 284 to the lower shaft opening 282 and between the first outer end 436 and the second outer end 462.

As shown in FIG. 9, in various embodiments, the outer surface 274 of the seat 204 may define the first flange 294 at the first outer end 436 and the second flange 296 at the second outer end 462. In various embodiments, the first flange 294 and the second flange 296 may be defined continuously around the seat 204 at the respective first outer end 436 and the second outer end 462.

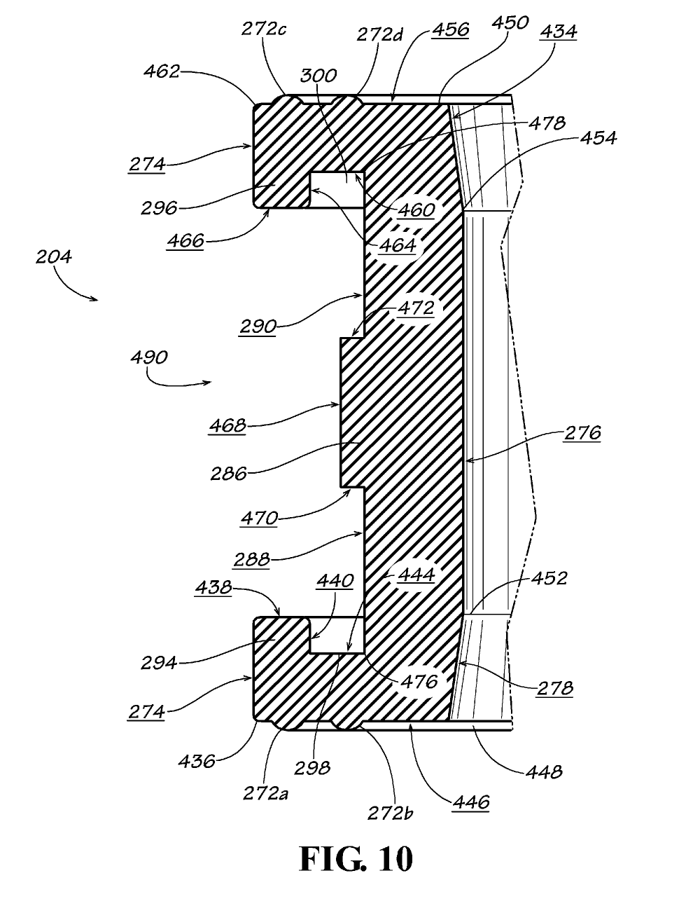

As shown in FIG. 9, in various embodiments, the first flange 294 and second flange 296 may extend partially into the center channel 490. In these embodiments, the extension by the first flange 294 into the center channel 490 may define a first seat groove 298 in the center channel 490 above the first recessed surface 288. Additionally, in these embodiments, the extension by the second flange 296 into the center channel 490 may define a second seat groove 300 in the center channel 490 above the second recessed surface 290. The surfaces and grooves of the seat will be described below in greater detail with reference to FIG. 10.

As shown in FIG. 9, in various embodiments, the outer surface 274 of the seat 204 may define the planar surface 280 around the lower shaft opening 282. In various embodiments, the planar surface 280 may have the same width as the inner surface 276 and extend between the first end 452 and the second end 454. The planar surface 280 may be utilized to facilitate rotation of the disc 302 when the valve assembly 200 is in operation. In addition, as shown in FIG. 10, the lower shaft opening 282 extends through the seat 204. In particular, in various embodiments, the lower shaft opening 282 may extend through the planar surface 280, the center rib 286, the first recessed surface 288, and the second recessed surface 290.

FIG. 10 is an enlarged view of one of the cross-sections of one embodiment of the seat 204 shown in FIG. 9. As shown in FIG. 10, the seat 204 includes the first outer end 436 and the second outer end 462. The seat 204 also may define a first inner end 448 and a second inner end 450.

In various embodiments, the seat 204 defines the first side surface 446 between the first outer end 436 and the first inner end 448. As previously discussed, in various embodiments, the seat 204 may include side ribs 272a,b on the first side surface 446. In various embodiments, the seat 204 may also define the second side surface 456 between the second outer end 462 and the second inner end 450. As shown in FIG. 10, in various embodiments, the seat 204 may include side ribs 272c,d on the second side surface 456.

A lower side of the seat 204 may be defined as the portion of the seat 204 between the first inner end 448 and the second inner end 450. As shown in FIG. 10, in various embodiments, the lower side of the seat 204 may include the inner surface 276 defined between the first end 452 and the second end 454. In these embodiments, the first end 452 may connect to the first inner end 448 through the tapered surface 278. The second end 454 may connect to the second inner end 450 through the tapered surface 434.

As previously discussed, in various embodiments, the outer surface 274 of the seat 204 may define the center channel 490 between the first outer end 436 and the second outer end 462. As shown in FIG. 10, the center channel 490 defines the first recessed surface 288 having a first end 476 and the second recessed surface 290 having a second end 480. The width of the center channel 490 may be defined as a distance between the first end 476 and the second end 480. As shown in FIG. 10, in various embodiments, the distance between the first end 476 and the second end 480 may be less than the distance between the first outer end 436 and the second outer end 462. The depth of the center channel 490 may be defined as a distance from the outer surface 274 to the first recessed surface 288 or the distance from the outer surface 274 to the second recessed surface 290.

In various embodiments, the center channel 490 includes the center rib 286 extending radially outward from the recessed surfaces 288,290 of the center channel 490 between the first recessed surface 288 and the second recessed surface 290. As shown in FIG. 10, in various embodiments, the center rib 286 may include a first side surface 470 and a second side surface 472. In these embodiments, the first side surface 470 may be substantially perpendicular to the first recessed surface 288 and the second side surface 472 may be substantially perpendicular to the second recessed surface 290 when viewed in a cross-sectional view. As shown in FIG. 10, the center rib 286 also may define a center rib surface 468 extending between the first side surface 470 and the second side surface 472. A height of the center rib 286 may be defined as the distance between the center rib surface 468 and the first recessed surface 288 or the distance between the center rib surface 468 and the second recessed surface 290. As shown in FIG. 10, surface 468,470,472 may define a square profile for the center rib 286 when viewed in a cross-sectional view; however, in various other embodiments, the surfaces 468,470,472 may interact to define a non-square profile for the center rib 286. For example, in various embodiments, the surfaces 468,470,472 may define a center rib 286 with a rounded profile, angled profile, or any other desired profile shape. As will be discussed below with reference to FIGS. 12 and 13, the profile of the center rib 286 defined by surfaces 468,470,472 should match the profile of the center groove 240 of the body 202.

As shown in FIG. 10, in various embodiments, the outer surface 274 of the seat 204 defines the first flange 294 at the first outer end 436. As shown in FIG. 10, the first flange 294 defines a side surface 438 and a lower surface 440. In these embodiments, the surfaces 274,438,440 may define a square profile for the first flange 294 when viewed in a cross-sectional view; however, in various other embodiments, the surfaces 274,438,440 may interact to define a non-square profile for the first flange 294. For example, in various embodiments, the surfaces 274,438,440 may define a first flange 294 with a rounded profile, angled profile, or any other desired profile shape.

In various embodiments, the first flange 294 may partially extend into the center channel 490 such that the lower surface 440 of the first flange 294 is positioned facing the first recessed surface 288. In these embodiments, the seat 204 may include a side surface 444 extending between the lower surface 440 and the first recessed surface 288. The surfaces 288,440,444 may define the first seat groove 298 between the first flange 294 and the first recessed surface 288. In these embodiments, the surfaces 288,440,444 may define a square profile for the first seat groove 298 when viewed in a cross-sectional view; however, in various other embodiments, the surfaces 288,440,444 may interact to define a non-square profile for the first seat groove 298. For example, in various embodiments, the surfaces 288,440,444 may define a first seat groove 298 with a rounded profile, angled profile, or any other desired profile shape.

As shown in FIG. 10, in various embodiments, the outer surface of the seat 204 defines the second flange 296 at the second outer end 462. As shown in FIG. 10, the second flange 296 defines a side surface 466 and a lower surface 464. In these embodiments, the surfaces 274,464,466 may define a square profile for the second flange 296 when viewed in a cross-sectional view; however, in various other embodiments, the surfaces 274,464,466 may interact to define a non-square profile for the second flange 296. For example, in various embodiments, the surfaces 274,464,466 may define a second flange 296 with a rounded profile, angled profile, or any other desired profile shape.

In various embodiments, the second flange 296 may partially extend into the center channel 490 such that the lower surface 464 of the second flange 296 is positioned facing the second recessed surface 290. In these embodiments, the seat 204 may include a side surface 460 extending between the lower surface 464 and the second recessed surface 290. The surfaces 290,460,464 may define a second seat groove 300 between the second flange 296 and the second recessed surface 290. In these embodiments, the surfaces 290,460,464 may define a square profile for the second seat groove 300 when viewed in a cross-sectional view; however, in various other embodiments, the surfaces 290,460,464 may interact to define a non-square profile for the second seat groove 300. For example, in various embodiments, the surfaces 290,460,464 may define a second seat groove 300 with a rounded profile, angled profile, or any other desired profile shape.

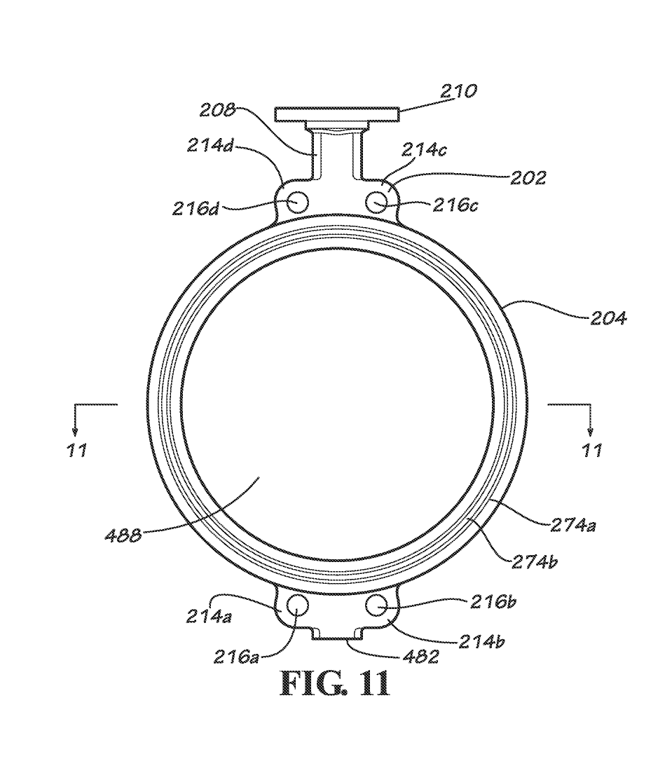

FIG. 11 shows a front view of one embodiment of a partially assembled valve assembly 200 with the seat 204 inserted into the body 202 of the valve assembly 200.

FIG. 12 shows a cross-sectional view of one embodiment of a partially assembled valve assembly 200 with the seat 204 inserted into the body 202 taken along line 11-11 in FIG. 11. As shown, in various embodiments, when the seat 204 is inserted into the body 202, the first outer end 230 of the body 202, the first outer end 436 of the seat 204, and the first inner end 448 of the seat 204 are at the same side of the valve assembly 200. In these embodiments, the side surface 400 of the body 202 and the first side surface 446 with ribs 272a,b of the seat 204 may define a first side of the body 202 and seat 204 assembly. Additionally, in these embodiments, the second outer end 232 of the body 202, the second outer end 462 of the seat 204, and the second inner end 450 of the seat 204 are at the same side of the valve assembly 200. In these embodiments, the side surface 402 of the body 202 and second side surface 456 with ribs 272c,d of the seat 204 may define a second side of the body 202 and seat 204 assembly.

As shown in FIG. 12, in the embodiments with the seat 204 inserted into the body 202, the outer surface 222 of the body 202 may be the outermost surface of the body 202 and seat 204 assembly. As shown in FIG. 12, the outer surface 222 may include grooves 224 defined in the outer surface 222 in various embodiments. In these embodiments, the grooves 224 may be the outermost grooves of the body 202 and seat 204 assembly.

In various embodiments, the inner surface 276 of the seat 204 may define the innermost surface of the body 202 and seat 204 assembly. As shown in FIG. 12 and as previously described, in various embodiments, the inner surface 276 of the seat 204 may define the planar surface 280 around the lower shaft opening 282. In these embodiments, the planar surface 280 and inner surface 276 may be the innermost surfaces of the body 202 and seat 204 assembly.

As shown in FIG. 12, when assembled, in various embodiments the first flange 294 of the seat 204 may be inserted and fill the first side groove 234 of the body 202 between the first outer body flange 442 and the first inner body flange 268. In various embodiments, the second flange 296 of the seat 204 may be inserted and fill the second groove 254 of the body 202 between the second outer body flange 458 and the second inner body flange 270. In various embodiments, the center rib 286 of the seat 204 may be inserted and fill the center groove 240 of the body 202.

FIG. 13 is an enlarged view of one of the cross-sections of one embodiment of the assembled body 202 and seat 204 shown in FIG. 12. As previously described, when the seat 204 is inserted into the body 202, the first flange 294 may be inserted into the first side groove 234 between the first outer body flange 442 and the first inner body flange 268. In these embodiments, the profile of the first flange 294 may be substantially similar to the profile of the first side groove 234. As shown in FIG. 13, in various embodiments, the first flange 294 may be inserted into the first side groove 234 such that at the first outer end 436 of the seat 204, the outer surface 274 may be adjacent to the lower surface 404, the side surface 438 may be adjacent to the groove surface 406, the lower surface 440 may be adjacent to the upper surface 408, and the side surface 410 may be adjacent to the side surface 444. In these embodiments, the first flange 294 fills the first side groove 234 for the entire length of the first side groove 234.

As previously described, in various embodiments, the second flange 296 may be inserted into the second side groove 256 of the body 202 between the second body outer flange 458 and the second body inner flange 470. In these embodiments, the profile of the second flange 296 may be substantially similar to the profile of the second side groove 256. As shown in FIG. 13, in various embodiments, the second flange 296 may be inserted into the second side groove 256 such that at the second outer end 462 of the seat, the outer surface 274 may be adjacent to the lower surface 420, the side surface 466 may be adjacent to the groove surface 422, the lower surface 464 may be adjacent to the upper surface 424, and the side surface 460 may be adjacent to the side surface 418. In these embodiments, the second flange 296 fills the second side groove 256 for the entire length of the second side groove 256.

As shown in FIG. 13, the center rib 286 may be inserted into the center groove 240 of the body 202. In these embodiments, the profile of the center rib 286 may be substantially similar to the profile of the center groove 240. As shown in FIG. 13, in these embodiments, the first recessed surface 288 may be adjacent to the inner surface 236, the second recessed surface 290 may be adjacent to the inner surface 236, the first side surface 470 of the center rib 286 may be adjacent to the first side groove surface 412 of the center groove 240, and the second side surface 472 of the center rib 286 may be adjacent to the second side groove surface 416 of the center groove 240.

As shown in FIG. 13, in various embodiments, the height of the center rib 286 may be less than the depth of the center groove 240. In these embodiments, when the center rib 286 is inserted into the center groove 240, a gap 474 may be defined between the center rib surface 468 and the groove bottom surface 414. In these embodiments, the center rib 286 fills the center groove 240 except for the gap 474 for the entire length of the center groove 240.

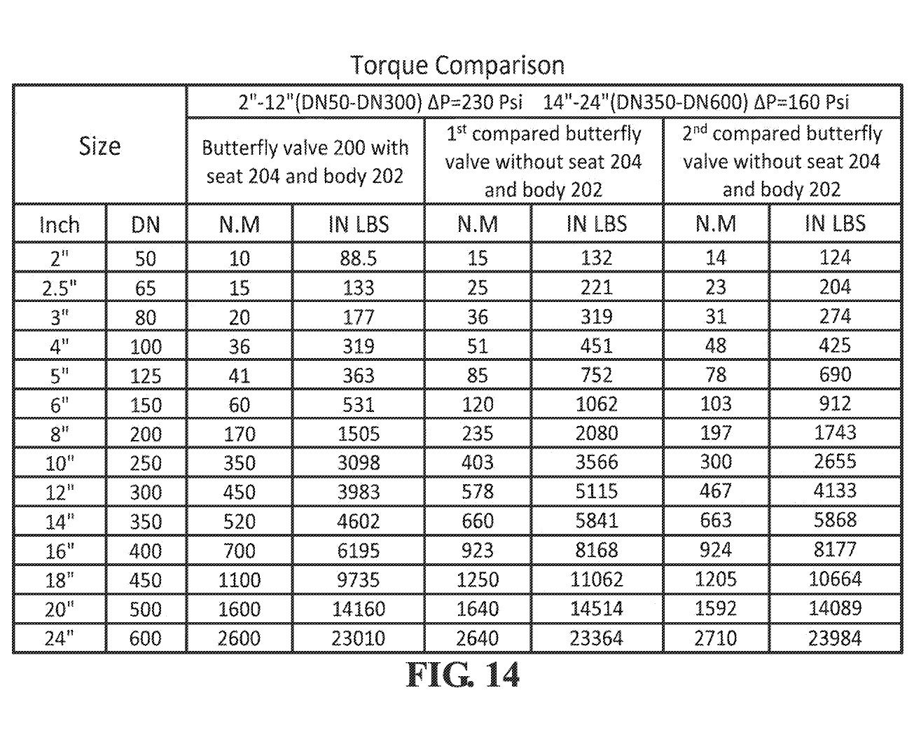

In these embodiments, the center rib 286 may lock the seat 204 in place in the body 202 for the entire length of the center groove 240. In various embodiments, locking the seat 204 in in place in the body 202 may prevent radial movement and axial movement of the seat 204. In various embodiments, the gap 474 may allow the seat 204 to be compressed into the center groove 240. In these embodiments, the gap 474 may allow for compression of the seat 204 during cycling of the valve assembly 200. In these embodiments, an operating torque for cycling the valve assembly 200 is reduced. The reduced operating torque will be described below in further detail with reference to FIG. 14.

Additionally, in these embodiments, when the first flange 294 is inserted into the first side groove 234, the second flange 296 is inserted into the second side groove 256, and the center rib 286 is inserted into the center groove 240, the ribs, flanges, and grooves may form a seal between the seat 204 and the body 202 extending the entire length of the respective grooves 234,240,256.

In various embodiments, as shown in FIG. 13, the seat 204 is inserted in the body 202 with nothing between the assembled seat 204 and body 202. In various embodiments, the inner surface 236 of the body 202 is in full contact with the seat 202 except for gap 474. In various embodiments, nothing fills the gap 474 defined between the center rib surface 468 and the groove bottom surface 414. By having the seat 204 inserted into the body 202 with nothing between the seat 204 and the body 202, a fluid tight seal is formed and potential leak lines are minimized, thus reducing the possibility of failure of the fluid tight seal. This configuration further reduces the need for additional elements, which would otherwise increase the number of potential leak lines, while providing a reduction in the operating torque, as described below. However, in other various embodiments, inner surface 236 may not be in full contact with the seat 202 or another element may be placed at some point between the seat 202 and the body 204, depending on the circumstances, and the disclosure of full contact between inner surface 236 and seat 202 should not be considered limiting on the current disclosure.

FIG. 14 is a table showing the reduced operating torque of a butterfly valve with a body 202 and seat 204 having a gap 474 as described above. As shown in FIG. 14, the operating torque of a butterfly valve with a body 202 and seat 204 was compared to the operating torque of a butterfly valve with a first comparison body and seat and the operating torque of a butterfly valve with a second comparison body and seat. In particular, the first comparison body and seat and the second comparison body and seat do not include the following elements: flanges such as flanges 268,270,294,296; center rib 286; center groove 240; and gap 474, among other elements. The operating torque was measured on pipes ranging in size from 2″ to 24″ (or 50 DN to 600 DN). As shown, the operating torque of the butterfly valve with the body 202 and seat 204 was less than the operating torque of the butterfly valve with the first comparison body and seat and the operating torque of the butterfly valve with the second comparison body and seat.

Referring back to FIG. 3, a method of assembling a valve assembly 200 is described in further detail. It should be noted that any of the steps of any of the methods described herein may be performed in any order or could be performed in sub-steps that are done in any order or that are separated in time from each other by other steps or sub-steps, and the disclosure of a particular order of steps should not be considered limiting on the current disclosure.

As shown in FIG. 3, the body 202 is initially provided. The seat 204 is then inserted into the body 202 such that: the first flange 294 is inserted into the first groove 234 and extending the entire length of the first groove 234; the second flange 296 is inserted into the second groove 256 and extending the entire length of the second groove 256; and the center rib 286 is inserted into the center groove 240 and extending the entire length of the center groove 240. In various embodiments, inserting the center rib 286 in the center groove 240 defines the gap 474 (shown in FIG. 13) extending the entire length of the center groove 240. Additionally, the seat 204 is inserted such that the upper shaft opening 284 is aligned with the upper neck shaft hole 244 and the lower shaft opening 282 is aligned with the lower neck shaft hole 262.

When the seat 204 is inserted into the body 202, the disc 206 may then be inserted into the central opening 488 of the seat 204, which partially includes the central opening 480 of the body 202. In various embodiments, the disc 206 is inserted into the seat 204 such that the seat 204 separates the disc 206 from the body 202. Additionally, the disc is inserted such that the upper shaft receiving opening 304 is aligned with the upper shaft opening 284 and the lower shaft receiving opening is aligned with the lower shaft opening 282.

Once the disc 206 is inserted into the central opening 488, the upper shaft 212 is inserted through the upper neck shaft hole 244, the upper shaft opening 284, and into the upper shaft receiving opening 304. The lower shaft 310 is inserted through the lower neck shaft hole 262, the lower shaft opening 282, and into the lower shaft receiving opening. In various embodiments, the upper shaft 212 is inserted such that the drive 360 of the upper shaft 212 is inserted into the upper shaft receiving opening 304 for positively engaging the disc 206. When the upper shaft 212 is inserted into the upper neck shaft hole 244, a portion of the upper shaft 212 between the first intermediary position 496 and the first end 350 extends above the top flange 210 for engagement with an actuator system. In various embodiments, the top flange 210 may include fastener holes 242 for securing an actuator system to the valve assembly 200.

In various embodiments, the upper bushing 362 may be inserted around the upper shaft 212 in the upper neck shaft hole 244. The upper bushing 362 may be inserted such that the upper shaft 212 extends through the central opening 390 of the upper bushing 362. In this configuration, the inner surface 370 of the upper bushing 362 is adjacent to the outer surface 358 between the first intermediary position 496 and second intermediary position 498 on the upper shaft 212. Additionally, the upper bushing 362 may be inserted such that the second end 352 is closest to the center groove 240 and the first end 350 is closest to the top flange 210.

In various embodiments, the V-type packing ring 372 may then be inserted around the upper shaft 212 and between the first intermediary position 496 on the upper shaft 212 and the first end 350 of the upper bushing 362. In these embodiments, the upper shaft 212 may be inserted through the central opening 388 of the V-type packing ring 372. Additionally, in these embodiments, the V-type packing ring 372 sits in the second recessed seat 502. The bearing 374 may then be inserted around the upper shaft 212 such that the upper shaft 212 extends through the central opening 386 and the bearing 374 is between the first intermediary position 496 and the first end 350 of the upper shaft 212.

In various embodiments, the top cap 376 may then be inserted onto the upper shaft 212. In these embodiments, the top cap 376 is inserted such that the upper shaft 212 extends through the central opening 384. Additionally, in these embodiments, the top cap 376 sits in the first recessed seat 484. Fasteners such as screws 382 may be inserted into attachment openings 380, through the top cap 376, and into fastener holes 242 to secure the top cap 376 to the body 202. In these embodiments, securing the top cap 376 to the body 202 also retains the upper shaft 212 in the body 202.

In various embodiments, the lower bushing 320 may be inserted around the lower shaft 310 in the lower neck shaft hole 262. The lower bushing 320 may be inserted such that the lower shaft 310 extends through the central opening 392 of the lower bushing 320. Additionally, the lower bushing 320 may be inserted such that the first end 312 is closest to the center groove 240 and the second end 314 is closest to the lower end 482 (shown in FIG. 4).

In various embodiments, the rotating mechanisms may be inserted into the lower neck shaft hole 262. As shown in FIG. 3, in various embodiments, the rotating mechanism may be thrust ball bearings 330. In these embodiments, the thrust ball bearings 330 may be inserted into the body 202 such that the first washer 332 of the thrust ball bearings 330 is adjacent to the second end of the lower shaft 310 and the second end 324 of the lower bushing 320.

The end cap 220 may then be inserted onto the body 202 at the lower neck shaft hole 262. In these embodiments, the end cap 220 may define the raised surface 344 extending from the top surface 500. The raised surface 344 may be dimensioned to fit within the lower neck shaft hole 262 and may be inserted into the lower neck shaft hole 262 such that the raised surface 344 is adjacent to the second washer 334. In various embodiments, the valve assembly 200 may further include the sealing mechanism such as O-ring 338. In these embodiments, the O-ring 338 is positioned around the raised surface 344. When the end cap 220 is attached to the body 202, the O-ring may create a seal between the end cap 220 and the body 202. The end cap 220 may be attached to the body 202 with fasteners such as screws 346. In these embodiments, the screws 346 may extend through attachment openings 340a,b,c,d and into the body 202.

This assembly configuration represents one of many possible assembly configurations. One skilled in the art will understand that obvious variations of this assembly configuration are included within this disclosure, including variations of steps, combinations of steps, and dissections of steps, among others. Where materials are chosen for the elements of this assembly, particularly rubber, metal, and plastic, similar material choices may also be used and would be obvious to one in the art. Additionally, the dimensions of the valve assembly may vary and be adapted depending on type of material used and particular application purpose. Furthermore, the configuration of the assembly need not be annular but could be another configuration depending on the application. Finally, additional components may be added to the valve assembly 200 and various components may be split into other components.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A valve assembly comprising:
a valve body having an inner surface defining a groove between a first end of the inner surface and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole;
a seat having an outer surface defining a rib extending outward between a first end of the outer surface and a second end of the outer surface, the rib having a rib outer surface, the rib positioned in the groove and extending from the upper neck shaft hole to the lower neck shaft hole, the groove defining a gap between the groove bottom surface and the rib outer surface.

2. The valve assembly of claim 1, wherein the valve body includes a first side defining a first side groove.

3. The valve assembly of claim 2, wherein the seat includes a first side defining a first side rib positioned in the first side groove of the valve body.

4. The valve assembly of claim 3, wherein the first side groove extends in a complete circle on the first side of the valve body and the first side rib of the seat fills the first side groove of the valve body.

5. The valve assembly of claim 3, wherein the valve body includes a second side defining a second side groove and the seat includes a second side defining a second side rib positioned in the second side groove of the valve body.

6. The valve assembly of claim 5, wherein the second side groove extends in a complete circle on the second side of the valve body and the second side rib of the seat fills the second side groove of the valve body.

7. The valve assembly of claim 1, wherein seat includes a first tapered surface and a second tapered surface, the first tapered surface extending inward from a first side of the seat and the second tapered surface extending inward from a second side of the seat, the first tapered surface and the second tapered surface facing at least partially radially inward.

8. The valve assembly of claim 1, wherein the valve assembly is a butterfly valve.

9. The valve assembly of claim 1, wherein the rib is deformable into the gap.

10. The valve assembly of claim 1, further comprising a disc positioned in a central opening defined by the seat, the disc rotatable in the central opening to open and close the central opening.

11. A method of manufacturing a valve assembly comprising:
forming a valve body having an inner surface defining a groove between a first end and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole;
forming a seat with an outer surface defining a rib extending outward between a first end and a second end of the outer surface; and
inserting the seat into the valve body by inserting the rib into the groove such that the rib extends from the upper neck shaft hole to the lower neck shaft hole and a gap is defined between a rib outer surface of the rib and the groove bottom surface of the groove.

12. The method of claim 11, wherein:
forming the valve body includes forming a first side groove in a first side of the valve body;
forming the seat includes forming a first side rib in a first side of the seat; and
inserting the seat into the valve body includes inserting the first side rib into the first side groove.

13. The method of claim 12, wherein:
forming the valve body includes forming a second side groove in a second side of the valve body;
forming the seat includes forming a second side rib in a second side of the seat; and
inserting the seat into the valve body includes inserting the second side rib into the second side groove.

14. The method of claim 11, further comprising placing a disc in a central opening defined by the seat such that the disc is rotatable in the central opening to open and close the central opening.

15. The method of claim 11, wherein forming the seat includes forming a first tapered surface and a second tapered surface, the first tapered surface extending inward from a first side of the seat and the second tapered surface extending inward from a second side of the seat, the first tapered surface and the second tapered surface facing at least partially radially inward.

16. The method of claim 11, wherein the valve assembly is a butterfly valve.

17. A method of operating a valve assembly, the method comprising:
rotating a disc of the valve assembly, the valve assembly further including:
a valve body having an inner surface defining a groove between a first end of the inner surface and a second end of the inner surface, the inner surface further defining an upper neck shaft hole and a lower neck shaft hole distal from the upper neck shaft hole, the groove having a groove bottom surface extending from the upper neck shaft hole to the lower neck shaft hole;
a seat having an outer surface defining a rib between a first end of the outer surface and a second end of the outer surface, the rib having a rib outer surface, the rib positioned in the groove and extending from the upper neck shaft hole to the lower neck shaft hole, the groove defining a gap between the groove bottom surface and the rib outer surface;
engaging the disc with the seat to close a central opening of the seat.

18. The method of claim 17, wherein engaging the disc with the seat includes compressing the seat into the gap between the groove surface and the rib surface.

19. The method of claim 17, wherein:
the seat includes a first tapered surface and a second tapered surface, the first tapered surface extending inward from a first side of the seat and the second tapered surface extending inward from a second side of the seat, the first tapered surface and the second tapered surface facing at least partially radially inward; and
engaging the disc with the seat includes engaging the disc with the first tapered surface and the second tapered surface.

20. The method of claim 17, wherein the valve assembly is a butterfly valve.
